(19) United States
(12) Patent Application Publication
(10) Pub. No.: US 2026/0365941 A1
(43) Pub. Date: Nov. 19, 2026

(54) SOLID FABRIC CARE FORMULATION

(71) Applicant: S H KELKAR AND COMPANY LIMITED, Mumbai (IN)

(72) Inventors: Abhijit SAHA, Mumbai (IN); Vijay PATIL, Mumbai (IN); Avani MAINKAR, Mumbai (IN); Kedar VAZE, Mumbai (IN)

(21) Appl. No.: 19/145,565

(22) PCT Filed: Jan. 4, 2024
(86) PCT No.: PCT/IN2024/050013

§ 371 Date: Jul. 3, 2025

(30) Foreign Application Priority Data
Jan. 7, 2023 (IN) 202221039069

(51) Int. Cl. C11D 3/00; C11D 3/04; C11D 3/12; C11D 3/22; C11D 3/30; C11D 3/37; C11D 17/06

(52) U.S. Cl. CPC C11D 3/001; C11D 3/046; C11D 3/124; C11D 3/221; C11D 3/222; C11D 3/30; C11D 3/3776; C11D 17/06

(57) ABSTRACT

A solid particulate formulation for softening textile fabrics comprises a softening agent, solidifying and dispersing aid, super disintegrant, microenvironment pH modifier, bulk material and optionally a flowing aid/anti-caking agent wherein said ingredients are in a ratio of 1:3:0.1:1:1 to 1:3:2:2:2. The softening agent is preferably a non-tallow-based ammonium ester quats derived from vegetable origin, the ingredients used in the preparation of the formulation are also environmentally friendly. The fabric softening formulation is biodegradable, stable, non-weeping and readily dispersible.

### FIELD OF THE INVENTION

The present invention relates to a fabric care composition. It is particularly related to a biodegradable, solid softening composition comprising non-tallow-based ammonium ester quats preferably derived from vegetable origin in synergistic combination with other ingredients of the composition favoring the beneficial attributes of ready dissolution and stability of the composition.

### BACKGROUND OF THE INVENTION

Quaternary ammonium compounds are known to impart “softness” to fabrics. Conditioning compositions containing quaternary ammonium compounds are generally liquid dispersions that are delivered into the rinsing bath through a dispenser, in an automatic process, or directly, in a manual process. Fabric softener (i.e., conditioning) compositions are commonly used to deposit a fabric softening compound onto the fabric. Typically, such compositions contain a cationic fabric softening agent dispersed in water. But the cationic surfactants are non-biodegradable and cause a huge concern to the environment, especially to the aquatic environment.

Unfortunately, liquid detergent compositions tend to be incompatible with softening compositions. Normally anionic surfactants are employed for liquid detergent compositions to aid cleaning of the clothing whereas cationic surfactants are principal ingredients for a softener. Use of an anionic surfactant and a cationic surfactant in a single package, can combine and form a solid precipitate. This results in problem with stability of the combination when packaged together in a liquid form or together in a wash liquor, and a decrease in cleaning performance compared to a detergent composition not comprising a softening composition. This incompatibility problem is one of the reasons that detergent compositions and fabric softening compositions are dosed and applied separately. Further, liquid formulations can be unstable upon long term storage at extreme weather conditions, such as freezing temperatures or extremely warm storage temperatures, leading to separation of the ingredients.

In contrast, the benefits of solid compositions include stability, compactness of the compositions to enable transportation of less weight thereby making shipping more economical, requirement of less packaging so that smaller and more readily disposable containers can be used, lesser chance for messy leakage, and requirement of lesser shelf space in the retail stores. Solid formulations are also more stable during storage, and extreme weather conditions. Attempts have been made to provide fabric softener in granular or powdered form.

EP 111074 discloses a powdered rinse conditioner based on a silica carrier for the softening agent. A disadvantage of using a carrier such as silica is that it can cause bulking of the product and appears to serve no function beyond making the powder compatible with other ingredients that may be contained in a washing powder.

WO 92/18593 describes a granular fabric softening composition comprising a non-ionic fabric softener and a single long alkyl chain cationic material. The specification teaches that effective cationic softening compositions when used in granular form exhibit poor dispersion properties and so, despite the advantages of being ecofriendly and saving on transportation, commercial exploitation of a water-free powdered rinse conditioner, is not evident.

EP0568297B1 discloses a powdered rinse conditioner comprising a water insoluble cationic active and a non-ionic dispersing agent. The problem with powdered rinse conditioners is that, once dissolved or dispersed in the rinse liquor, it is difficult to achieve good deposition of the softening agent onto the fabric being treated. Deposition aids have been proposed for depositing clay softeners. For example, WO-A1-00/60039 discloses a solid rinse conditioner comprising clay, surfactant, a solid carrier and a flocculating agent which aids deposition of the clay. The preferred flocculating agent is an organic polymer such as polyethylene oxide.

JP 62057639 discloses the production of cationic surfactant granules in which a dialkyl quaternary ammonium powder is granulated with an alkali metal chloride or an alkaline earth metal chloride. Here, chloride is used to improve softness.

In addition to the effort to increase the level of fabric softener active in the liquid composition or usable solid formulation, another significant improvement in the fabric softener art is the development of rapidly biodegradable fabric softener actives to improve the environmental friendliness of fabric softener products. The new actives consist mainly of cationic quaternary ammonium compounds containing long chain alkyl groups, with at least one ester functional group inserted in some or all of the long chain alkyl groups.

Despite the many advantages and approaches listed above, it is still a challenge to develop a formulation of a solid softener that has a performance comparable to a liquid softener of the same kind and amount of active content. A major challenge in producing a solid softener is developing a formulation that will not melt, “weep”, or separate during typical storage and transport temperatures. Some softening actives, such as dimethyl distearyl ammonium chloride, are themselves already solids at room temperature, so there is little challenge in formulating them into a non-weeping composition. These solid softening actives are effective at softening, but they are not biodegradable and are not considered environmentally friendly. Preferred softening actives such as triethanolamine diester quats, one example of which is methyl bis (ethyl tallowate)-2-hydroxyethyl ammonium methyl sulfate are biodegradable. These biodegradable actives are typically low melting solids that are semi-solid at room temperature, and are much harder to formulate into a non-weeping product.

### OBJECTS OF THE INVENTION

The principal object of the present invention is to provide a stable, non-weeping solid fabric conditioning, softening, rinse-off aid, in particulate form.

Another object of the present invention is to provide a stable, non-weeping solid fabric conditioning, softening, rinse-off aid based on monocationic alkyl ammonium salts, which is made up of non-tallow, vegan or plant-based origin.

Yet another object of the present invention is to provide a solid fabric conditioning, softening, rinse-off aid which would achieve rapid dispersion in water at ambient temperature.

Still another object of the present invention is to provide a solid fabric conditioning, softening, rinse-off aid which would be environment friendly and biodegradable.

Still yet another object of the present invention is to provide a solid fabric conditioning, softening, rinse-off aid in powder form or particulate form wherein the size of the particulates should be less than 300 μm for fast dissolution in water.

A further object of the present invention is to provide a solid fabric conditioning, softening, rinse-off aid wherein the bending length is not more than 4.0 cm, moisture is not more than 5%, and suspended particles is also not more than 5%.

Yet another object of the present invention is to provide a method of preparation of a cost-effective and easy to scale up solid fabric conditioning, softening, rinse-off aid.

### SUMMARY OF THE INVENTION

The present invention provides a biodegradable, solid fabric conditioning, softening, rinse-off formulation in the form of granules comprising a non-tallow-based cationic softening ammonium ester quats, preferably derived from vegetable origin. The formulation comprises selective proportion of a solidifying and dispersing aid, super disintegrants, microenvironment pH modifier, bulk materials, and flowing aids or anti-caking agents. The average particle size of said granules is less than 300 μm, and hence undergoes faster and ready dispersion in water at ambient temperature. Said super disintegrants used in the formulation also help in rapid dissolution of the granules wherein the salt of a strong acid and a weak base is used as a microenvironment pH modifier while being dispersed in water to adjust the pH to a value below 5.5. The resultant composition is in the form of a non-weeping, stable powder, and can be procured as a packaged product.

### DETAILED DESCRIPTION OF THE INVENTION

Definitions for some of the terms used in the present invention are presented herein.

‘Bending angle’ also known as “bending length” is half the length of rectangular strip of fabric that will bend under its own weight to an angle of 41.5°. It is measured in centimeters. Fabrics with high bending length are stiffer, lack good drape, and lack flexibility. Hence, the optimum bending length is not more than 4.0 cms.

As stated hereinbefore, the present invention provides a formulation for a solid fabric softening composition comprising biodegradable non-tallow-based ammonium ester quats, preferably from vegetable origin, and procured as a packaged product.

The present invention provides a biodegradable solid fabric softening formulation comprising a cationic softening agent, solidifying and dispersing aid, super disintegrants, microenvironment pH modifier, bulk materials and flowing aids or anti-caking agents. Said cationic softening agent of the present invention is monocationic alkyl ammonium salt which is a non-tallow-based ammonium compound, and is biodegradable.

The primary embodiment of the present invention provides a solid, biodegradable, stable, non-weeping fabric softening formulation. As mentioned hereinbefore, non-biodegradability of the cationic surfactants causes a huge concern to the environment, especially to the aquatic environment. It is reported that triethanolamine based diester quaternary ammonium compounds or ester quats are biodegradable in nature. Hence, the present invention employs dialkylester ammonium methosulfate, preferably triethanolamine esterquat methosulphates based on mainly C_{16/18} saturated and unsaturated fatty acids of vegetable origin such as di(palm carboxyethyl) hydroxyethyl methyl ammonium methyl sulfate as a softening agent. Said cationic fabric softening agents are typically low melting or waxy solids at room temperature. Mono-, di-, and oligo-saccharides such as glucose, fructose, sucrose, galactose, ketose, etc. either singularly or in combination are used as solidifying and dispersing aids.

According to an embodiment of the present invention, solidifying and dispersing aids, super disintegrants, microenvironment pH modifier, bulk materials, flowing aids or anti-caking agents are used in the solid fabric formulation to impart easy dispersing capability, free flowing character and bulk to the cationic fabric softening agent. Solidifying and dispersing aids employed in the present invention may be selected from a group comprising of mono, di, and oligosaccharides, such as glucose, fructose, sucrose, galactose, ketose, and the like. Super disintegrants employed in the present invention may be selected from a group comprising of value-added products such as crosslinked polyvinylpyrrolidone, sodium starch glycolate, magnesium aluminum silicate, crosslinked starch, crosslinked alginic acid, calcium silicate, and crosslinked cellulose. Said super disintegrants have been procured as a packaged product from the counter, for experimental purpose. A salt of a strong acid and a weak base is used as a microenvironment pH modifier, while being dispersed in water, to adjust the pH to below 5.5. Said microenvironment pH modifier may be selected from ammonium chloride, diethanolamine hydrochloride, N-butyl-diethanolamine hydrochloride, triethanolamine hydrochloride, and ammonium sulfate. In addition, one or more bulk materials are selected from cyclodextrins, maltodextrins, sodium sulphate, sodium chloride, and potassium chloride. The flowing aids or anti-caking agents used in the present invention include precipitated silica, clay, and modified starches, or mixtures thereof.

According to an embodiment of the present invention, the biodegradable solid fabric softening formulation comprises softening agent, solidifying and dispersing aid, super disintegrant, microenvironment pH modifier, and bulk material in the ratio of 1:3:0.1:1:1 to 1:3:2:2:2.

According to an embodiment of the present invention, the biodegradable solid fabric softening formulation comprises 5-14.9% w/w of softening agent, 5-40%, preferably 15.5-39.9% w/w of solidifying and dispersing aid, 0.5-23.5% w/w of super disintegrants, 5-35% w/w of microenvironment pH modifier, 5-29% w/w of bulk materials, and optionally 0.1-5% w/w of flowing aids or anti-caking agents.

According to an embodiment of the present invention, the biodegradable solid fabric softening formulation comprises 2-5% w/w of super disintegrants along with the other ingredients to achieve biodegradability of >95%.

According to another embodiment of the present invention, said granular softening formulation is prepared by an easy and facile process comprising of:
i. mixing a softening agent with a solidifying and dispersing aid;
ii. heating the above mixture at 60-80 °C with stirring which is continued until the ingredients disperse homogeneously in liquid state;
iii. heating super disintegrant(s) at 60-80 °C, and adding said hot super disintegrant(s) to the mixture obtained in step (ii) and heating at 60-80 °C, while continuing stirring to obtain a homogeneous mixture;
iv. heating a mixture of solid microenvironment pH modifier and bulk materials at 60-80 °C;
v. adding said hot mixture obtained in step (iv) to the homogeneous mixture obtained in step (iii), and stirred until a homogeneity is obtained followed by cooling the mixture to ambient temp (25 °C);
vi. grinding the solidified mass obtained from step (v) using a grinder; and
vii. passing the ground materials obtained in step (vi) through a selective mesh to obtain a solid fabric softening composition of size less than 300 μm.

The yield of the particulate formulation is 90% or more by weight of granules with size 4 mm or less after step v of the above process, and results in fine particulate formulation which contains 75% or more by weight of particles with D(4,3) value of 275 μm or less. Incorporation of a super disintegrant in the range of 0.5% to 23.5%, and an average particle size below 300 μm facilitates faster dissolution in water at 25 °C.

The present invention will be more readily understood from the following non-limiting exemplary illustrations of formulation of the solid fabric softening composition and process for the preparation thereof. It is to be understood that both the foregoing general description and the following detailed description are exemplary, and are intended to provide further explanation of the invention as claimed that should not be construed to limit the scope of the present invention.

Various fabric softeners such as STEPANTEX® SP-90 (purchased from Stepan), and Arquad® 2 HT-75 (purchased from Merck) were considered for evaluation of the efficacy of the formulation of the present invention. The desired dosage is less than 5 g per kg of dry fabrics. 12% w/w Arquad® 2 HT-75 resulted in a high particle size and high bending length. STEPANTEX® SP-90 exhibited good results in terms of softening, and hence it has been used as the preferred softening agent in the examples illustrated below.

### Example 1

A fabric softening formulation was prepared in accordance with the embodiments of the present invention, wherein said formulation comprises of 5% w/w of STEPANTEX® SP-90, 37.3% w/w of sugar, 20.2% w/w of crosslinked polyvinylpyrrolidone, 7% w/w NH₄Cl, 29% w/w of maltodextrin, and 1.5% w/w precipitated silica.

### Example 2

A fabric softening formulation was prepared in accordance with the embodiments of the present invention, wherein said formulation comprises of 14.9% w/w of STEPANTEX® SP-90, 36.1% w/w of sugar, 11.5% w/w of crosslinked polyvinylpyrrolidone, 7% w/w NH₄Cl, 29% w/w of maltodextrin, and 1.5% w/w precipitated silica.

### Example 3

A fabric softening formulation was prepared in accordance with the embodiments of the present invention, wherein said formulation comprises of 3% w/w of STEPANTEX® SP-90, 31% w/w of sugar, 10% w/w of crosslinked polyvinylpyrrolidone, 28% w/w NH₄Cl, 26.5% w/w of maltodextrin, and 1.5% w/w precipitated silica.

### Example 4

A fabric softening formulation was prepared in accordance with the embodiments of the present invention, wherein said formulation comprises of 18% w/w of STEPANTEX® SP-90, 21% w/w of sugar, 10% w/w of crosslinked polyvinylpyrrolidone, 23% w/w NH₄Cl, 26.5% w/w of maltodextrin, and 1.5% w/w precipitated silica.

### Example 5

A fabric softening formulation was prepared in accordance with the embodiments of the present invention, wherein said formulation comprises 14% w/w of STEPANTEX® SP-90, 13% w/w of sugar, 12% w/w of crosslinked polyvinylpyrrolidone, 32.3% w/w NH₄Cl, 27% w/w of maltodextrin, and 1.5% w/w precipitated silica.

### Example 6

A fabric softening formulation was prepared in accordance with the embodiments of the present invention, wherein said formulation comprises 14% w/w of STEPANTEX® SP-90, 45% w/w of sugar, 12% w/w of crosslinked polyvinylpyrrolidone, 19.5% w/w NH₄Cl, 8% w/w of maltodextrin, and 1.5% w/w precipitated silica.

### Example 7

A fabric softening formulation was prepared in accordance with the embodiments of the present invention, wherein said formulation comprises 14% w/w of STEPANTEX® SP-90, 39% w/w of sugar, 5% w/w of crosslinked polyvinylpyrrolidone, 25% w/w NH₄Cl, 15.5% w/w of maltodextrin, and 1.5% w/w precipitated silica.

### Example 8

A fabric softening formulation was prepared in accordance with the embodiments of the present invention, wherein said formulation comprises 14% w/w of STEPANTEX® SP-90, 25% w/w of sugar, 27% w/w of crosslinked polyvinylpyrrolidone, 25% w/w NH₄Cl, 7.5% w/w of maltodextrin, and 1.5% w/w precipitated silica.

### Example 9

A fabric softening formulation was prepared in accordance with the embodiments of the present invention, wherein said formulation comprises 14% w/w of STEPANTEX® SP-90, 39% w/w of sugar, 15% w/w of crosslinked polyvinylpyrrolidone, 3% w/w NH₄Cl, 27.5% w/w of maltodextrin, and 1.5% w/w precipitated silica.

### Example 10

A fabric softening formulation was prepared in accordance with the embodiments of the present invention, wherein said formulation comprises 14% w/w of STEPANTEX® SP-90, 20% w/w of sugar, 10% w/w of crosslinked polyvinylpyrrolidone, 40% w/w NH₄Cl, 15% w/w of maltodextrin, and 1.5% w/w precipitated silica.

### Example 11

A fabric softening formulation was prepared in accordance with the embodiments of the present invention, wherein said formulation comprises 14% w/w of STEPANTEX® SP-90, 31.5% w/w of sugar, 20% w/w of crosslinked polyvinylpyrrolidone, 30% w/w NH₄Cl, 3% w/w of maltodextrin, and 1.5% w/w precipitated silica.

### Example 12

A fabric softening formulation was prepared in accordance with the embodiments of the present invention, wherein said formulation comprises 14% w/w of STEPANTEX® SP-90, 32.5% w/w of sugar, 10% w/w of crosslinked polyvinylpyrrolidone, 5% w/w NH₄Cl, 37% w/w of maltodextrin, and 1.5% w/w precipitated silica.

### Example 13

A fabric softening formulation was prepared in accordance with the embodiments of the present invention, wherein said formulation comprises 14.7% w/w of STEPANTEX® SP-90, 24.8% w/w of sugar, 2% w/w of crosslinked polyvinylpyrrolidone, 28% w/w NH₄Cl, 29% w/w of maltodextrin, and 1.5% w/w precipitated silica.

Moisture content (%) analysis was carried out using a Halogen Moisture analyzer (Model HE 53) from Mettler Toledo. 0.5 g of the sample was placed on a pan, closed with the lid of the instrument, and heated at from 50 °C to 160 °C at a rate of 40 °C/sec. The moisture content (%) was assessed by calculating the loss of weight of the sample after the analysis.

Particle Size Analysis (PSA) was done using a Malvern Mastersizer 3000 with Aero S. 2-3 g of powder sample was placed in the Aero S powder feeder. Then a blank run was conducted, then the sample was passed through Aero S equipment under an air pressure of 22-24 psi at an obscuration rate of 6-14, and the particle size (D(4,3)) value was obtained.

Analysis % of suspended particles: A dispersion of the sample was prepared by adding 2.5 g of the sample to a beaker containing 1000 ml of water and stirred at 400 rpm using magnetic needle (8×50 mm) for 60 seconds on a Heidolph magnetic stirrer. Said dispersion was immediately filtered through a small steel net of a mesh size of 240. The water content present in the steel net was drained gently and weighed (W1). The washed steel net was dried and then dipped in the filtered liquor for 5 minutes. The water present in the steel net was drained gently, and the mesh is weighed again (W2). The percentage of suspended particles is calculated as represented below:

% Suspended particles=((W1−W2) in g/2.5 g)×100%

Softening assessments were carried out as follows.

Fabric softening formulations were prepared as shown in Examples 1-13. Example 2 and Examples 4-12 were prepared by adding 2.5 g of the sample to a beaker containing 1000 ml of water and stirred at 400 rpm using magnetic needle (8×50 mm) for 60 seconds on a Heidolph magnetic stirrer to prepare a dispersion. Fabric softening formulations presented in Examples 1 and 3, were prepared using 7.45 g and 12.42 g respectively to achieve a softener loading in the formulation that is equivalent to the softener loading of Example 2. pH electrode was added in the solution to measure the pH of the solution. Washed and dried cotton fabric strips were cut to a size of 2.5*20 cm (0.39±0.02 g each, 6 strips) and dipped in the above solution for 15 min, and dried under normal conditions. The dried strips were used to measure the bending length at a bending angle at 41.5° using ASTM D1388-18. The value of this bending length is used as a standard to measure the best range of bending length of different ingredients in the formulation.

The moisture content (%), particle size (μm), % suspended particles, and the bending length (cm) of the formulations prepared in Examples 1-13 which impact the efficacy in terms of rendering softening to the fabric, are shown in Table 1.

TABLE 1

| | Properties | | | |
|---|---|---|---|---|
| | | | | Bending |
| | Moisture | Particle | % Suspended | length |
| Examples | (%) | Size (μm) | particles | (cm) |
| Example 1 | 4 | D(4,3) - 290 | 5 | 4.0 |
| Example 2 | 5 | D(4,3) - 295 | 2 | 3.5 |
| Example 3 | 10.68 | D(4,3) - 281 | 6 | 4.8 |
| Example 4 | 5.36 | D(4,3) - 517 | 8 | 3.6 |
| Example 5 | 4.91 | D(4,3) - 403 | 6 | 3.7 |
| Example 6 | 3.55 | D(4,3) - 460 | 9 | 3.9 |
| Example 7 | 3.12 | D(4,3) - 653 | 10 | 3.6 |
| Example 8 | 5.57 | D(4,3) - 364 | 6 | 3.4 |
| Example 9 | 4.72 | D(4,3) - 362 | 6 | 3.9 |
| Example 10 | 3.8 | D(4,3) - 607 | 16 | 3.6 |
| Example 11 | 4.17 | D(4,3) - 440 | 7 | 3.7 |
| Example 12 | 7.13 | D(4,3) - 294 | 5 | 4.4 |
| Example 13 | 5 | D(4,3) - 295 | 4.5 | 3.7 |

It is evident from Table 1 that in examples 1 and 2, properties such as moisture %, particle size, % of suspended particles, and bending lengths. The ideal ranges are 4-5% moisture, 250-300 μm particle size, not more than 5% suspended particles, and 4.0 cm or less bending length, to achieve desired free-flowing, dissolution, and softening effect on the fabric.

Use of less amount of softening agent, i.e., less than the desired range of 5-14.9% w/w is used in the fabric care formulation, as shown in example 3, higher moisture content is observed, thereby lacking the free-flowing effect. Use of an increased amount of softening agent in the formulation, as shown in example 4, resulted in granules with particle size more than 500 μm thereby taking longer for dissolution.

Use of decreased or increased amounts of solidifying and dispersing aid in the fabric care formulation, i.e., amounts less than or more than the desired range of 15.5-39.9% w/w, as shown in example 5 and example 6 respectively, resulted in granules with particle size more than 400 μm, thereby increasing % of suspended particles to more than 5%.

Use of decreased or increased amounts of super disintegrants in the fabric care formulation, i.e., amounts less than or more than the desired range of 10-23.5% w/w, as shown in example 7 and example 8 respectively, resulted in granules with particle size more than 350 μm, thereby increasing % of suspended particles to more than 5%.

Use of decreased or increased amount of microenvironment pH modifier in the fabric care formulation, i.e., amounts less than or more than the desired range of 5-35% w/w, as shown in example 9 and example 10 respectively, resulted in granules with particle size more than 350 μm, thereby increasing % of suspended particles to more than 5%.

Use of lesser amount of bulk material than the desired range of 5-29% w/w in the fabric care formulation, as shown in example 11, resulted in granules with particle size more than 400 μm, thereby increasing % of suspended particles to more than 5%. Use of an increased amount of bulk material in the formulation, as shown in example 12, led to increased bending length of the fabric, thereby indicated decreased softening effect on the fabric.

The biodegradable solid fabric softening formulation in accordance with the various embodiments of the present invention, comprises softening agent, solidifying and dispersing aid, super disintegrants, microenvironment pH modifier, bulk materials in a ratio of 1:3:0.1:1:1 to 1:3:2:2:2. Said composition optionally further comprises flowing aids or anti-caking agents. Said softening agent is a non-tallow, vegan or plant-based monocationic alkyl ammonium salt, said solidifying and dispersing aid is a mono, di, or oligosaccharide, said super disintegrant is selected from crosslinked polyvinylpyrrolidone, sodium starch glycolate, magnesium aluminum silicate, crosslinked alginic acid, calcium silicate, crosslinked starch and crosslinked cellulose, said pH modifier is ammonium chloride, diethanolamine hydrochloride, N-butyl-diethanolamine hydrochloride, triethanolamine hydrochloride, or ammonium sulfate, said bulk material is a cyclodextrin or maltodextrin, and said flowing aid or anti-caking agent is silica, clay, or modified starch. Said solid fabric care formulation having a particle size less than 300 μm, bending length not more than 4.0, moisture % not more than 5%, and % suspended particles not more than 5, is biodegradable, stable, non-weeping, and rapidly dispersible in water at ambient temperature, cost-effective and easy to scale up.

It is to be understood, however, that the present invention would not be limited by any means to the techniques, and approaches that are not specifically described, and any change and modifications to the techniques and approaches can be made without departing from the spirit and scope described in the present invention.

1. A solid fabric care formulation comprising of:
i. a softening agent;
ii. a solidifying and dispersing aid;
iii. a super disintegrant;
iv. a microenvironment pH modifier;
v. a bulk material; and
vi. optionally a flowing aid or anti-caking agent,
vii, wherein the ingredients (i)-(v) are in a ratio of 1:3:0.1:1:1 to 1:3:2:2:2.

2. The solid fabric care formulation as claimed in claim 1, wherein said softening agent used is a non-tallow, vegan or plant-based monocationic alkyl ammonium salts.

3. The solid fabric care formulation as claimed in claim 1, wherein said solidifying and dispersing aid is a monosaccharide, disaccharide, or an oligosaccharide selected from glucose, fructose, sucrose, galactose, and ketose.

4. The solid fabric care formulation as claimed in claim 1, wherein said super disintegrant is selected from a group consisting of crosslinked polyvinylpyrrolidone, sodium starch glycolate, magnesium aluminum silicate, crosslinked starch, crosslinked alginic acid, calcium silicate, and crosslinked cellulose.

5. The solid fabric care formulation as claimed in claim 1, wherein said microenvironment pH modifier is selected from a group consisting of ammonium chloride, diethanolamine hydrochloride, N-butyl-diethanolamine hydrochloride, ammonium sulfate, and triethanolamine hydrochloride.

6. The solid fabric care formulation as claimed in claim 1, wherein said bulk material is selected from cyclodextrin, maltodextrin, sodium sulphate, sodium chloride, and potassium chloride.

7. The solid fabric care formulation as claimed in claim 1, wherein said flowing aid or anti-caking agent is selected from a group consisting of silica, clay, and modified starch.

8. The solid fabric care formulation as claimed in claim 1, wherein said formulation is in powder or granular form having a particle size of less than 300 μm.

9. The solid fabric care formulation as claimed in claim 1, wherein said formulation is biodegradable, stable, non-weeping, and rapidly dispersible in water.

10. The solid fabric care formulation as claimed in claim 1, wherein said formulation is a fabric conditioning or softening or rinse off aid formulation.

11. The solid fabric care formulation as claimed in claim 1, wherein said formulation upon dispersion in water exhibits a bending length of 4.0 cm or less for treated fabrics.

12. The solid fabric care formulation as claimed in claim 1, wherein said formulation has moisture content not more than 5%.

13. The solid fabric care formulation as claimed in claim 1, wherein said formulation has % suspended particles not more than 5 in an aqueous dispersion.
